(19) United States
(12) Patent Application Publication
(10) Pub. No.: US 2026/0211704 A1
(43) Pub. Date: Jul. 23, 2026

(54) WALLPAPER ENHANCEMENT BASED ON RENDERED USER INTERFACES AND WIDGETS

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 19/032,343

(22) Filed: Jan. 20, 2025

(51) Int. Cl. G06F 9/451; G06F 3/04845; G06T 13/80

(52) U.S. Cl. CPC G06F 9/451; G06F 3/04845; G06T 13/80; G06T 2200/24

(57) ABSTRACT

An electronic device provides techniques for creating appealing and eye catching home screens that combine animated and integrated wallpaper features with useful information from a widget, personalizing the electronic device and improving a user experience. A processor is configured to cause the electronic device to: (i) analyze a wallpaper to identify characteristics of enabling portion(s) thereof to be presented as a background or a foreground image; (ii) analyze the widget to identify presentation content that should be visible in a foreground of the first wallpaper; (iii) assign a fixed or a moving location of the widget relative to the first wallpaper presented in a background of a combined image; and (iv) generate and render an animated combined display image comprising the first widget presented in the assigned one of the fixed or the moving location with presentation content visible relative to the foreground or background of the first wallpaper.

### BACKGROUND

### 1. Technical Field

The present disclosure relates generally to electronic devices capable of presenting visual and audio content, and more particularly to electronic devices that capture and store visual and audio content for later presentation.

### 2. Description of the Related Art

Electronic devices such as smartphones, tables, laptops, and desktop workstations are operated by users for a myriad of functions such as office automation, communication and entertainment. A home screen or start screen is the main screen on a device or computer program. Home screens are not identical, in part because users may select a background image, which may be static or animated. Home screens are also not identical, in part because users rearrange static icons (i.e., shortcuts) or dynamic icons (i.e., widgets) on one more scrollable screens. A widget on a computer is a small application or tool often displayed on the desktop or within a user interface and that provides quick access to information or functions, such as weather updates, news headlines, or calendar events. Widgets help users interact with applications without needing to open the applications fully, providing a simpler and more convenient application user interface for performing a task or obtaining information.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates a block diagram of a wallpaper-widget integration/animation module of the electronic device configured to select, overlay, and animate/recolor a combination of wallpaper and widget for display by the electronic device, according to one or more embodiments;

FIG. 3A illustrates a display of the electronic device presenting, at a first time, a first animated combined display image including a first wallpaper of a stationary ramp with a first widget positioned at the top, according to one or more embodiments;

FIG. 3B illustrates the display of the electronic device of FIG. 3A presenting, at a second time subsequent to the first time, the first animated combined display image with the first widget moved to near the bottom of the stationary ramp, according to one or more embodiments;

FIG. 4A illustrates the display of the electronic device presenting, at a first time, a second animated combined display image including a second wallpaper of a closed flowering plant that hides a second widget, according to one or more embodiments;

FIG. 4B illustrates the display of the electronic device of FIG. 4A presenting, at a second time subsequent to the first time, the second animated combined display image with the first wallpaper animated to an opened flowering plant to expose the first widget, according to one or more embodiments;

FIG. 5A illustrates the display of the electronic device presenting, at a first time, a third animated combined display image including a third wallpaper of a dolphin playing with a third widget near seafloor flora and bubbles, according to one or more embodiments;

FIG. 5B illustrates the display of the electronic device of FIG. 5A presenting, at a second time subsequent to the first time, the third animated combined display image animated to move together the dolphin with the second widget and to move the seafloor flora and the bubbles, according to one or more embodiments;

FIG. 6A illustrates the display of the electronic device presenting, at a first time, a fourth animated combined display image including a fourth wallpaper of a fresh rose illuminated by a fourth widget presenting a battery fully charged value, according to one or more embodiments;

FIG. 6B illustrates the display of the electronic device of FIG. 6A presenting, at a second time subsequent to the first time, the fourth animated combined display image animated to move and recolor the rose and petals of the rose to a partially wilted state in correspondence to fourth widget presenting a battery partially discharged value, according to one or more embodiments;

FIGS. 7A - 7B (collectively "FIG. 7") are a flow diagram presenting a computer- implemented method for creating an animated combination of wallpaper and widget for displaying by an electronic device, according to one or more embodiments; and

FIGS. 8A - 8B (collectively "FIG. 8") are a flow diagram presenting a computer- implemented method for providing wallpaper and widget selection interface window that prompts finding combination(s) suitable for animating in the combined image, according to one or more embodiments.

### DETAILED DESCRIPTION

According to aspects of the present disclosure, an electronic device, a method, and a computer program provide various techniques for creating appealing and eye catching home screens that combine animated and integrated wallpaper features with useful information from a widget, personalizing the electronic device and improving user experience. Home screen customization has emerged as a pivotal feature for users seeking to personalize their electronic devices, such as smartphones. Beyond choosing wallpapers, including animated "live" wallpapers, to reflect individual tastes and moods, the introduction of widgets has revolutionized the user experience. Widgets allow for real-time information updates and quick access to information without opening applications ("apps"), providing instant access to relevant data, and thus enhancing usability and efficiency. In an example, the widgets may display weather forecasts, calendar events, or fitness goals. These features make widgets seemingly indispensable tools for productivity and convenience. An evolution of both wallpapers and widgets supports a shift from static to interactive home screens, where users can curate their digital environments to suit their daily needs. Moreover, the aesthetic appeal remains significant, with themes and customization options allowing users to create visually appealing interfaces that resonate with their personal style. Overall, the emphasis on home screen customization illustrates a broader trend towards user- centric design, where smartphones not only serve functional purposes but also serve as expressions of individuality and adds efficiency in daily life.

The present disclosure recognizes that current wallpaper selection and widget selection are independent choices. There are currently no efforts to automatically select combinations that work well together and that may be interactively animated to create an improved and more appealing home screen. The present disclosure addresses the current challenge that lies in the static and often uninspiring placement of widgets on smartphone home screens. This prime digital real estate offers an opportunity to innovate by seamlessly integrating widgets in a more engaging and dynamic manner. By enhancing their visual appeal and interaction, widgets can capture users' attention more effectively, ensuring the user notices and engages with the content the widgets provide. In one or more embodiments, the electronic device determines that a widget or another small user interface (UI) is being placed on an underlying background animated image. The electronic device detects and analyzes the UI being rendered. In parallel, the electronic device analyzes the background image, determines the best placement of the UI (e.g., widget) on the background based on the analyses, and generates a new composite animated experience. The integration of wallpaper and widget in the composite animated experience not only enhances user experience by making information more accessible and visually appealing but also presents a significant opportunity for businesses. Increased user engagement with dynamic widgets can lead to higher interaction rates with promotional content and services, thereby benefiting businesses seeking to connect more effectively with their target audience. Embracing this opportunity involves rethinking how widgets are designed and displayed, ensuring they blend functionality with aesthetic appeal to create a more integrated and engaging user experience on smartphone home screens.

According to one or more embodiments, an electronic device has a display and a memory including a widget and background integration module, one or more widget(s), and one or more wallpaper(s). A processor is communicatively coupled to the display and the memory. The processor is configured to cause the electronic device to identify a display setting to concurrently present a first widget of the one or more widget with a first wallpaper of the one or more wallpaper. The processor is configured to cause the electronic device to analyze the first wallpaper to identify characteristics of the first wallpaper enabling one or more portion thereof to be presented as a background or a foreground image. The processor is configured to cause the electronic device to analyze the first widget to identify presentation content that should be visible in a foreground of the first wallpaper. The processor is configured to cause the electronic device to assign one of a fixed and a moving location of the first widget relative to the first wallpaper presented in a background of a combined image. The location is selected in part based on the identified characteristics of the first wallpaper and the presentation content of the first widget. The processor is configured to cause the electronic device to generate and render an animated combined display image comprising the first widget presented in the assigned one of the fixed or the moving location with the presentation content visible relative to the foreground or background of the first wallpaper.

According to one or more embodiments, a computer-implemented method is provided for creating an animated combination of wallpaper and widget for displaying by an electronic device. The method includes identifying a display setting to concurrently present a first widget of one or more widget with a first wallpaper of the one or more wallpaper. The method includes analyzing the first wallpaper to identify characteristics of the first wallpaper enabling one or more portion thereof to be presented as a background or a foreground image. The method includes analyzing the first widget to identify presentation content that should be visible in a foreground of the first wallpaper. The method includes assigning one of a fixed and a moving location of the first widget relative to the first wallpaper presented in a background of a combined image. The location is selected in part based on the identified characteristics of the first wallpaper and the presentation content. The method includes generating and rendering an animated combined display image comprising the first widget presented in the assigned one of the fixed or the moving location with presentation content visible relative to the foreground or background of the first wallpaper.

Further embodiments provide a computer program product that includes: a non- transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to "one embodiment," "an embodiment," "embodiments", or "one or more embodiments" are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms "a", "an", and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

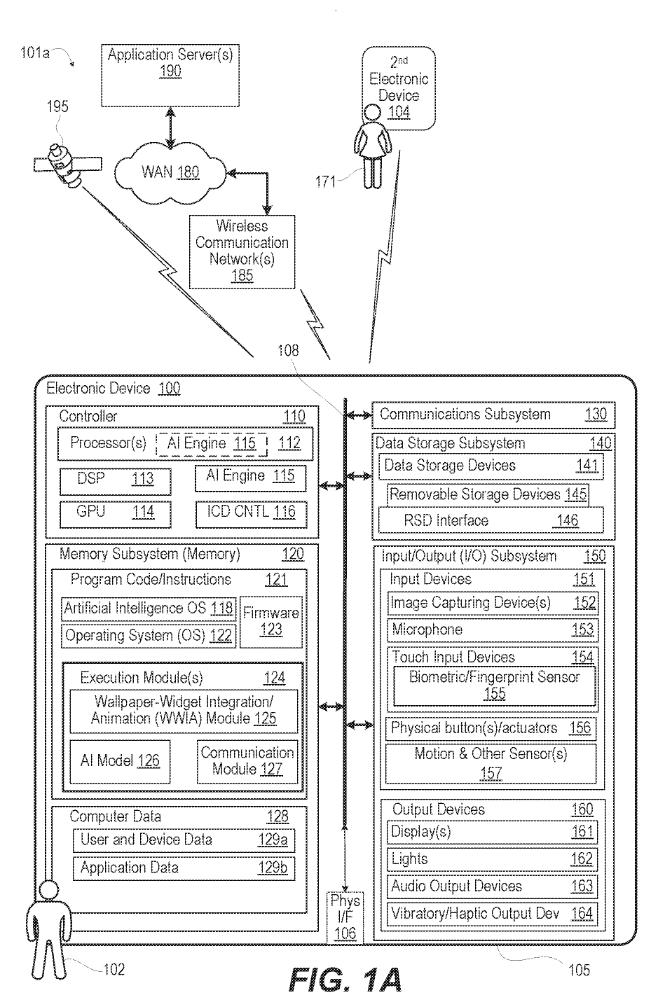

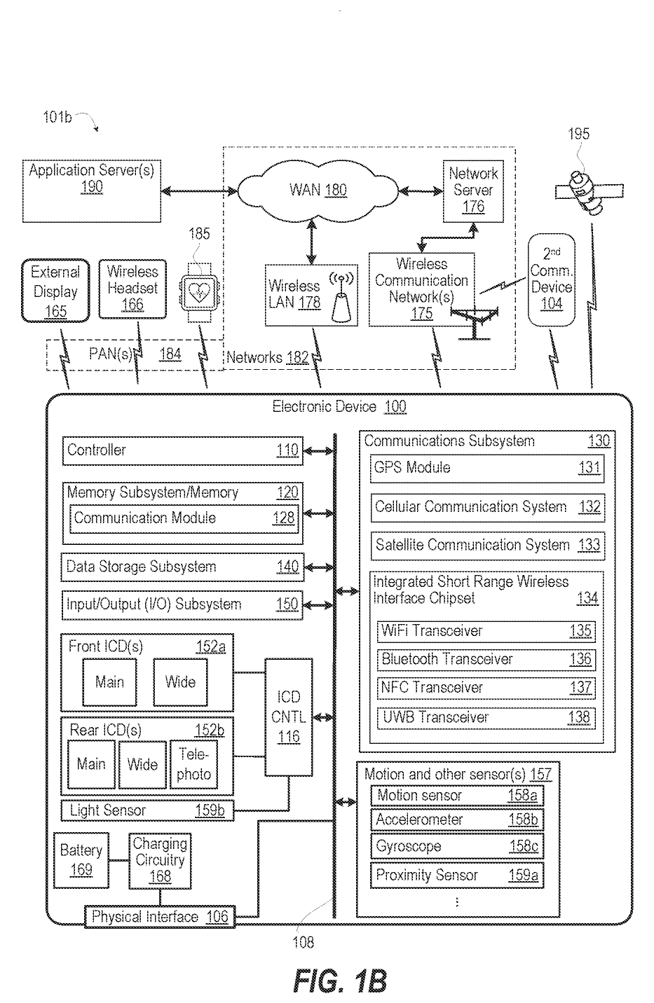

Those of ordinary skill in the art will appreciate that the hardware components and basic configuration depicted in the following figures may vary. For example, the illustrative components within electronic device 100 (FIGS. 1A - 1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term "communicatively coupled" means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can,in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 118.

Memory subsystem (or memory) 120 may include a combination of volatile and non- volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for simplicity) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, wallpaper-widget integration/animation (WWIA) module 125, which provides the features and operating functionality of the disclosed embodiments when the corresponding program instructions of WWIA module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within WWIA module 125 and is trained to support the AI features of WWIA module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, WWIA module 125 can include program instructions that cause or configure processor 112 to cause electronic device 100 to associate user activities with journal entries, such as by using natural language processing, image recognition, and audio speech recognition. Other features provided by WWIA module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate "data" that originated as raw, real-world "analog" information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s)141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of WWIA module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A , FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of WWIA module 125 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

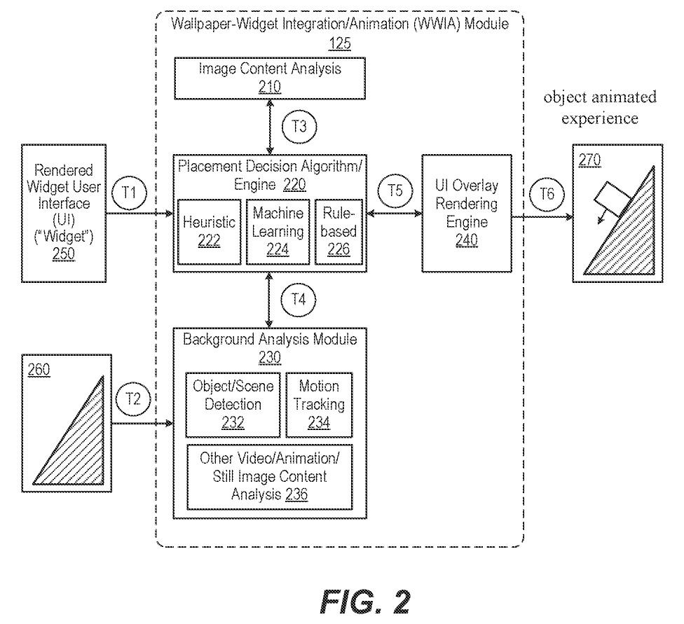

FIG. 2 illustrates a block diagram of a wallpaper-widget integration/animation module (WWIA) module 125 configured to select, overlay, and animate/recolor a combination of wallpaper and widget for display by electronic device 100 FIG. 1A. WWIA module 125 includes image content analysis 210, placement decision algorithm/engine 220, background analysis module 230, and UI overlay rendering engine 240. Placement decision algorithm/engine 220 may include one or more of heuristic module 222, machine learning module 224, and rule-based module 226. Background analysis module 230 may include one or more of object/scene detection module 232, motion tracking module 234, and other video/animation/still image content analysis module 236. Placement decision algorithm/engine 220 of WWIA module 125 receives, at a first time "T1", a rendered widget user interface ("widget") 250. Background analysis module 230 of WWIA module 125 receives, at a second time "T2", wallpaper 260. First time T1 and second time T2 may be concurrent. At a third time, "T3", placement decision algorithm/engine 220 analyzes widget 250. At a fourth time, "T4", background analysis module 230 collaborates with placement decision algorithm/engine 220 to analyze wallpaper 260. At a fifth time, "T5", placement decision algorithm/engine 220 transfers widget 250, wallpaper 260, and results of the analyses to UI overlay rendering engine 240 for rendering. At a sixth time, "T6", UI overlay rendering engine 240 generates animated combined display image 270 for an object animated experience. Animated combined display image 270 includes widget 250 presented in an assigned one of a fixed or a moving location with presentation content of widget 250 visible relative to the foreground or background of wallpaper 260.

Widgets 250 are an important aspect of home screen customization providing important and readily accessible app information and functionality. Widgets 250 are generally a small user interface (UI) providing "at-a-glance" views that users can manually move across their home screen panels, and, if supported, resize to tailor the amount of information in the widget to the user's preference. As one example, information widgets typically display crucial information elements and track how that information changes over time. Examples of information widgets are weather widgets, clock widgets, or sports score tracking widgets. Tapping information widgets typically launches the associated app and opens a detailed view of the widget information. Collection widgets specialize in displaying multiple elements of the same type, such as a collection of pictures from a gallery app, a collection of articles from a news app, or a collection of emails or messages from a communication app. Collection widgets can scroll vertically. Collection widgets typically focus on the following use cases: (i) browsing the collection; (ii) opening an element of the collection to an element detail view in the associated app; and (iii) interacting with elements, such as marking the element done. Control widgets display frequently used functions so that the user can trigger the frequently used functions from the home screen without having to open the app. Control widgets act as remote controls for an app. An example of a control widget is a home control widget that lets users turn lights in the house on or off. Interacting with a control widget might open an associated detail view in the app. In an example, the control widget may operate as a search widget to output data. Some widgets 250 are hybrid widgets incorporating aspect of two or more types of widgets.

In one or more embodiments, WWIA module 125 provides a solution for wallpaper enhancement based on rendered user interfaces and widgets. In an example, WWIA module 125 determines that a widget or a small UI is being placed on an underlying background animated image. Using various image content analysis techniques, WWIA module 125 detects and analyzes the UI being rendered. In one or more embodiments, WWIA module 125 performs obj ect detection using convolutional neural network (CNN) models like ImageNet, YOLO, SSD, Faster RCNN etc. ImageNet is an image database organized according to the WordNet hierarchy, in which each node of the hierarchy is depicted by hundreds and thousands of images. You only look once (YOLO) is a popular real-time object detection algorithm that uses a single neural network to perform both classification and prediction of bounding boxes for detected objects. Single Shot Multi Box Detector (SSD) is an object detection algorithm based on deep learning that can greatly improve the detection speed and ensure the detection accuracy. Faster Region-based Convolutional Network (R-CNN) is a state-of-the-art object detection model that integrates Region Proposal Networks (RPN) with Fast R-CNN to achieve real-time object detection.

In another example, WWIA module 125 provides feature extraction using semantic segmentation and extraction techniques such as using U-Net, Deeplab, scale-invariant feature transform (SIFT), ORB, etc. U-Net is a fully convolutional neural network that was developed for image segmentation and whose architecture was modified and extended to work with fewer training images and to yield more precise segmentation. DeepLab provides semantic image segmentation with deep convolutional nets, atrous convolution, and fully connected conditional random fields (CRF). Oriented FAST and rotated BRIEF (ORB) provides features from accelerated segment test (FAST) and binary robust independent elementary features (BRIEF). ORB provides a corner detection method used to extract feature points and used to track and map objects in many computer vision tasks.

In an additional example, WWIA module 125 provides extraction and analysis of the text within the UI using various optical character recognition (OCR) techniques. In a further example, WWIA module 125 provides for identifying the intent of the UI through various image captioning techniques.

Using various animated image content analysis techniques, WWIA module 125 analyzes the background by one or more: (i) object detection using traditional computer vision(CV) techniques (e.g., feature detection, edge detection, object classification) and/or deep learning techniques (e.g., YOLO, Faster RCNN, etc.); (ii) semantic segmentation to understand the scene composition and identify different regions on background; (iii) motion tracking of various objects using techniques such as optical flow analysis (i.e., to analyze movement patterns), Kalman filters (i.e., to predict future object positions) and/or particle filters (i.e., track change in appearances, etc.); and (iv) key point detection to identify stable regions in the image for UI placement.

WWIA module 125 determines the best placement of the UI (widget) on the background based on widget content analysis and the background analysis. Various techniques may include: (i) rule-based mechanisms which may include generic rules like "place UI on top of detected object" or "place object in an empty area that does not obstruct the animation", or specific rules based on detected object such as, "if the object is moving toy (swing), place the widget on the moving toy (swing)", or "if the object is animal (dolphin), then place the object on dolphin's mouth", etc. The various techniques may further include: (ii) supervised machine learning models that consider the extracted features (e.g., object, location, size, motion pattern, etc.) to predict best placement; (iii) optimization algorithms that explore various placement options to select the ones with best fitness score based on predefined criteria (e.g., visibility, user interaction, aesthetic appeal, etc.)

Based on the predicted best placement, WWIA module 125 generates the new composite animated experience (i.e., animated combined display image 270). In one or more embodiments, generating the animated combined display image 270 may include: (i) calculating UI (i.e., widget 250) trajectory based on placement decision and background motion; (ii) overlaying widget 250 on the background (i.e., wallpaper 260) using techniques such as alpha compositing and perspective correction; and (iii) generating a final composite animated output.

In one or more embodiments, WWIA module 125 may generate multiple composite animated experiences based on user selection of one or both wallpaper and widget. In one or more embodiments, the background image (e.g., wallpaper 260) may not be animated and WWIA module 125 may animate wallpaper 260 and then blend widget 250 on top of the resultant animated image.

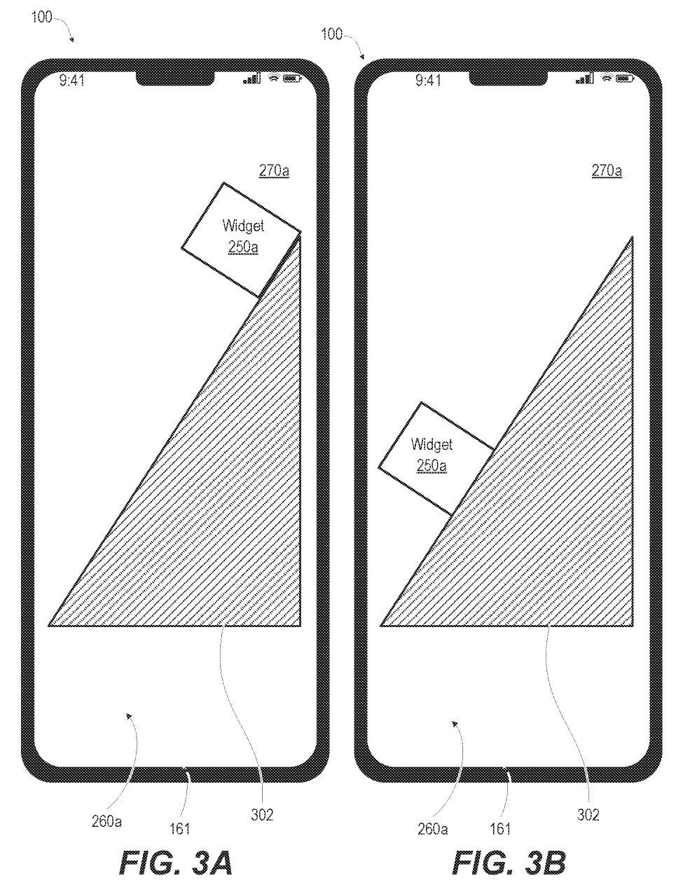

FIG. 3A illustrates display 161 of electronic device 100 presenting, at a first time, first animated combined display image 270a including first wallpaper 260a presenting stationary ramp 302 with first widget 250a positioned at the top. FIG. 3B illustrates display 161 of electronic device 100 of FIG. 3A presenting, at a second time subsequent to the first time, first animated combined display image 270a with first widget 250a moved to near the bottom of stationary ramp 302. In between first and second times, first widget 250a moves smoothly between top and bottom positions simulating sliding down the stationary ramp 302 and then first widget 250a resets back to the top of stationary ramp 302 to repeat the animation. In one or more embodiments, an inanimate object such as a ramp may also be modified and rendered as a non-stationary ramp that moves, such as by alternatingly tipping one way and the other with the widget sliding back and forth. In an example, positioning and sizing of first widget 250a may be static options provided by program code 121 for configuring presentation of first widget 250a. By incrementation changing one or more image characteristic such as position and sizing of first widget 250, electronic device 100 animates first widget 250a.

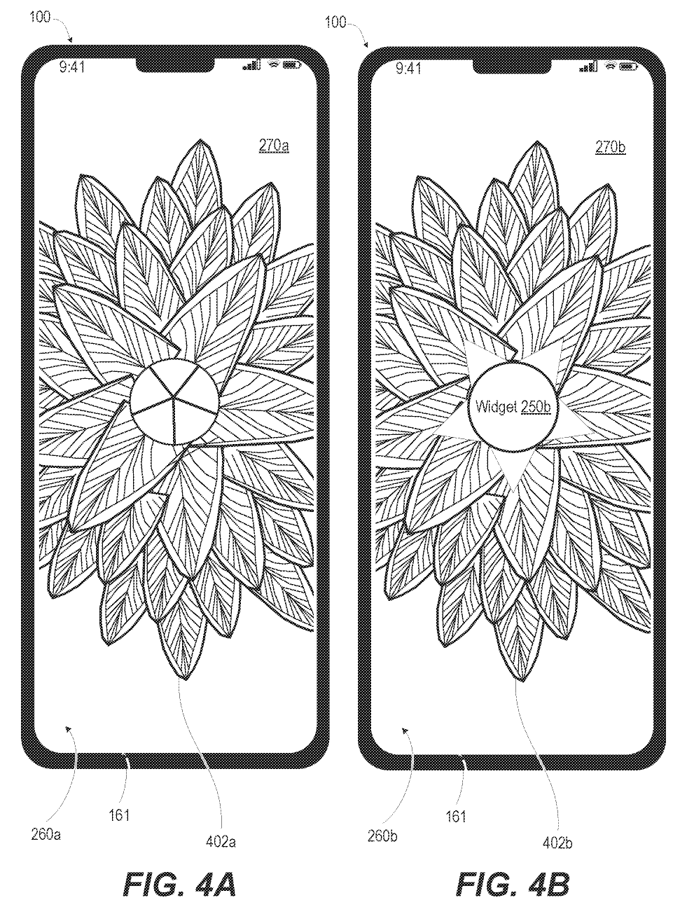

FIG. 4A illustrates display 161 of electronic device 100 presenting, at a first time, second animated combined display image 270b including second wallpaper 260b having closed flowering plant 402a that selectively hides second widget 250b (FIG. 4B). FIG. 4B illustrates display 161 of electronic device 100 of FIG. 4A presenting, at a second time subsequent to the first time, second animated combined display image 270b with second wallpaper 260b animated to present opened flowering plant 402b to expose second widget 250b. In an example, second wallpaper 260b includes a time-lapsed photograph of a flowering plant that is shown opening in a visually continuous manner from the closed flower plant 402a of FIG. 4A to open flowering plant 402b of FIG. 4B. In one or more embodiments, electronic device 100 flips between closed flower plant 402a of FIG. 4A to open flowering plant 402b of FIG. 4B. In one or more embodiments, wallpaper 260b initially includes only one image of either closed flower plant 402a or open flowering plant 402b. Electronic device 100 may perform image recognition to determine that flowering plant has both an open and a closed position that provides an opportunity for animation to reveal second widget 250b. Electronic device 100 may animate second wallpaper 260b by generating and rendering the other one of closed flower plant 402a or open flowering plant 402b that is sized and positioned to correspond to provided one of closed flower plant 402a or open flowering plant 402b.

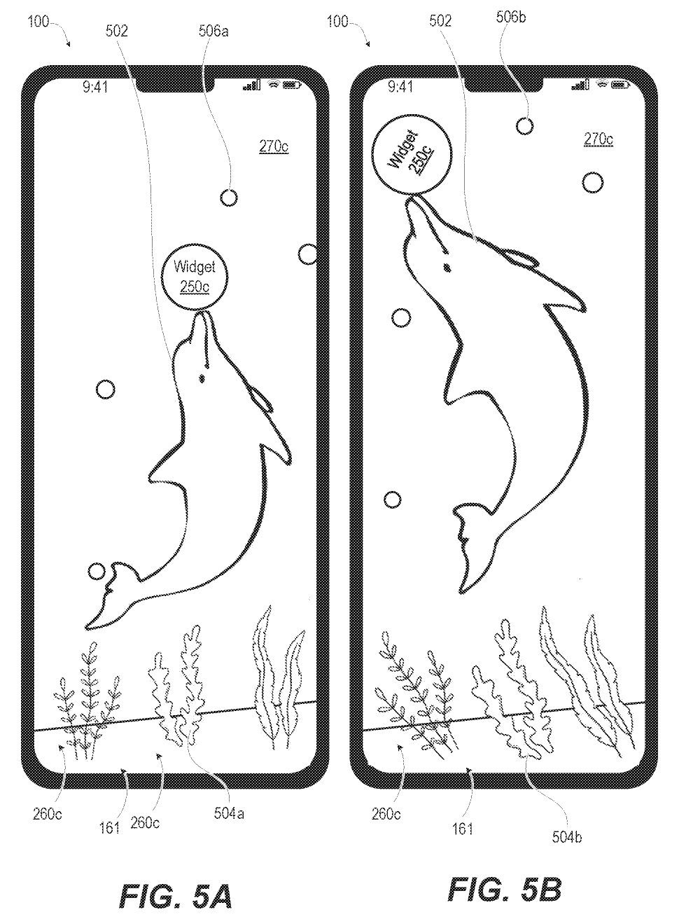

FIG. 5A illustrates display 161 of electronic device 100 presenting, at a first time, third animated combined display image 270c including third wallpaper 260c having dolphin 502 playing with third widget 250c near seafloor flora 504a and bubbles 506a. In one or more embodiments, a wallpaper may include one or more examples of fauna (e.g., fish, birds, insects, mammals, etc.), either stationary or animated. FIG. 5B illustrates display 161 of electronic device 100 of FIG. 5A presenting, at a second time subsequent to the first time, third animated combined display image 270c animated to move dolphin 502 together with second widget 250c, which is rotating, and to also move seafloor flora 504b and bubbles 506b. In other embodiments, other objects (e.g., snowflakes, leaves, dust, tumbleweeds, comets, and sand) associated with other natural backgrounds (e.g., desert, space, beach, mountains, prairie, urban landscape) may also be moved to natural movement. In one or more embodiments, dolphin 502 may already be animated. In one or more embodiments, dolphin 502 may be static until electronic device 100 generates an animated version of a static wallpaper. In an example, electronic device 100 performs image recognition to identify dolphin 502, distinguishing dolphin 502 from a background. Electronic device 100 performs image modification techniques such as changing the size, orientation, and position of dolphin 502 incrementally to create an image of continuous movement from a first position of dolphin 502 in FIG. 5A to a second position of dolphin 502 in FIG. 5B. The background provided by wallpaper 260c that are not visible in FIG. 5A due to dolphin 502 being in the first position are filled by matching adjacent portions of the background that are visible. In one or more embodiments, the modification to the background utilizes "magic eraser" techniques. In one or more embodiments, electronic device 100 may substitute a three-dimensional model that corresponds to a two-dimensional image, enabling movement of particular portions of an object, such as flippers and tail fin, and allowing for three-dimensional rotation of the object to further enhance the animation. In an example, by recognizing dolphin 502, electronic device 100 may access a three-dimensional model of a dolphin, size the three-dimensional model to match dolphin 502, and skin the three dimensional model with the two-dimensional image to include portions not visible in the first position of FIG. 5A. The three-dimensional model would provide features that may be moved relative to other portions.

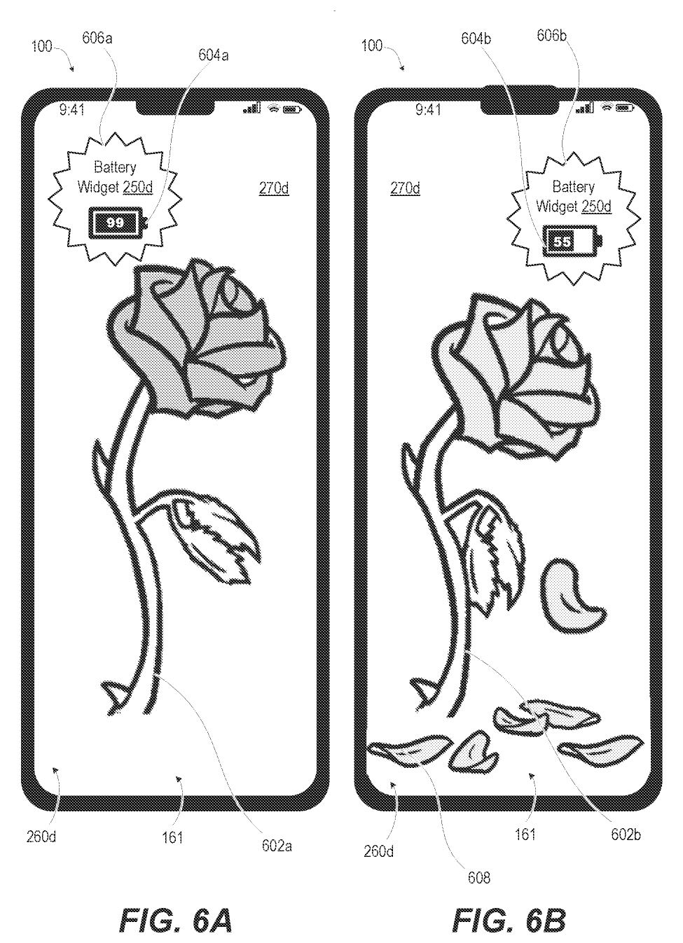

FIG. 6A illustrates display 161 of electronic device 100 presenting, at a first time, fourth animated combined display image 270d including fourth wallpaper 260d having fresh rose 602a illuminated by fourth widget 250d presenting battery icon 604a with a battery fully charged value (e.g., "99"). Fourth widget 250a also includes day/night animated lighting source 606a at a first time position. FIG. 6B illustrates display 161 of electronic device 100 of FIG. 6A presenting, at a second time subsequent to the first time, fourth animated combined display image 270d animated to move and recolor fresh rose 602a (FIG. 6A) and detached petals 608 to present partially wilted rose 602b in correspondence to fourth widget 250d presenting battery icon 604b with a battery partially discharged value (e.g., "55"). The animation may continue to an almost fully discharged state (e.g., "1") with a fully dead flower stem with few or no attached pedals and colors of dark brown or similar colors. Fourth widget 250a also includes day/night animated lighting source 606b moved to a second time position. Static presentation options of fourth widget 250d may be incrementally changed to animate fourth widget 250d. Thus, some embodiments provide the functionality of presenting an intuitive indication of a device operating characteristic that does not require reading an alphanumeric value. The value such as battery state may be readily understood without having to focus on display 161, which may be particularly useful in hands-free operation such as when driving a vehicle. In one or more embodiments, other system values may be intuitively presented, such as communication channel quality, available memory storage, memory device service life, device internal temperature,

With returning reference particularly to FIG. 1A, according to aspects of the present disclosure, electronic device 100 has display 161 and memory 120 including: (i) widget and background integration (WBI) module 125 (ii) one or more widget 250 (FIG. 2); and (iii) one or more wallpaper 260 (FIG. 2). Processor 112 of electronic device 100 is communicatively coupled to memory 120 and display 161. Processor 112 is configured to cause electronic device 100 to identify a display setting to concurrently present a first widget of the one or more widget 250 (FIG. 2) with a first wallpaper of the one or more wallpaper 260 (FIG. 2). Processor 112 is configured to cause electronic device 100 to analyze the first wallpaper to identify characteristics of the first wallpaper enabling one or more portion thereof to be presented as a background or a foreground image. Processor 112 is configured to cause electronic device 100 to analyze the first widget to identify presentation content that should be visible in a foreground of the first wallpaper. Processor 112 is configured to cause electronic device 100 to assign one of a fixed and a moving location of the first widget relative to the first wallpaper presented in a background of a combined image, the location selected in part based on the identified characteristics of the first wallpaper and the presentation content. Processor 112 is configured to cause electronic device 100 to generate and render an animated combined display image including the first widget presented in the assigned one of the fixed or the moving location with presentation content visible relative to the foreground or background of the first wallpaper.

In one or more embodiments, in response to receiving a user input identifying selection of the first wallpaper from among a plurality of selectable wallpapers 260 (FIG. 2) to apply to display 161 of electronic device 100, processor 112 is configured to cause electronic device 100 to identify visual and functional characteristics of the first wallpaper that support concurrent presentation of a particular type and form of widget. Processor 112 is configured to cause electronic device 100 to autonomously select, from among a plurality of widgets, the first widget having a shape that corresponds to the particular type and form suitable for concurrent presentation with the first wallpaper having the visual and functional characteristics.

In one or more embodiments, in response to receiving a user input identifying selection of the first widget from among a plurality of widgets, processor 112 is configured to cause electronic device 100 to identify visual and functional characteristics of the first widget that support concurrent presentation with a particular type and form of wallpaper 260 (FIG. 2). Processor 112 is configured to cause electronic device 100 to autonomously select from among a plurality of wallpapers 260 (FIG. 2), the first wallpaper having features that correspond to the particular type and form suitable for concurrent presentation with the first widget having the visual and functional characteristics.

In one or more embodiments, the first widget presents a characteristic having a first value from among multiple possible values. Processor 112 is configured to cause electronic device 100 to visually alter an image characteristic of the first wallpaper in relation to the first value, such as depicted in FIGS. 6A - 6B. In one or more embodiments, the first wallpaper is animated and the fixed or moving location of the first widget is selected and dynamically changeable relative to the animation of the first wallpaper.

In one or more embodiments, in response to the first wallpaper not being an animated wallpaper, processor 112 is further configured to cause electronic device 100 to identify one or more portions of the first wallpaper that can be presented with animated movement. Processor 112 is further configured to cause electronic device 100 to modify a presentation of the first wallpaper to present the one or more portions as animated portions within animated combined display image 270 (FIG. 2). An example of animating an object is described above, such as regarding dolphin 502 of FIGS. 5A - 5B.

In one or more embodiments, processor 112 is further configured to cause electronic device 100 to apply, to animated combined display image 270 (FIG. 2), at least one animation effect from a group comprising: (i) sliding movement of the first widget along the first wallpaper, such as depicted in FIGS. 3A - 3B; (i) movement of at least a portion of the first wallpaper revealing the first widget, such as depicted in FIGS. 4A - 4B; (ii) spinning movement of the first widget, such as depicted in FIGS. 5A - 5B; or (iv) aligned movement of the first widget and at least a portion of the first wallpaper, such as depicted in FIGS. 6A - 6B.

In one or more embodiments, in response to the first wallpaper not being an animated wallpaper, processor 112 is further configured to cause electronic device 100 to present the animated combined display image as an animated image by adding at least one animated object over the first wallpaper and the first widget. In one or more embodiments, the at least one animated object includes one or more of: (i) leaf; (ii) snowflake; (iii) bubble 506a (FIG. 5A); (iv) wave; (v) waving flora 504a (FIG. 5A); (vi) moving fauna; and (vii) day/night animated lighting source 606a (FIG. 6A).

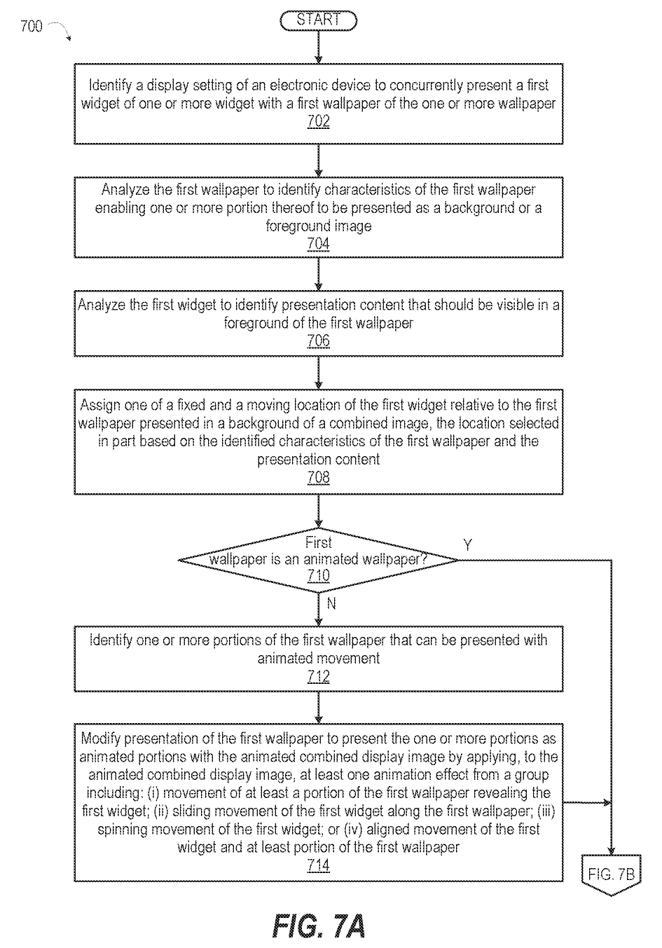

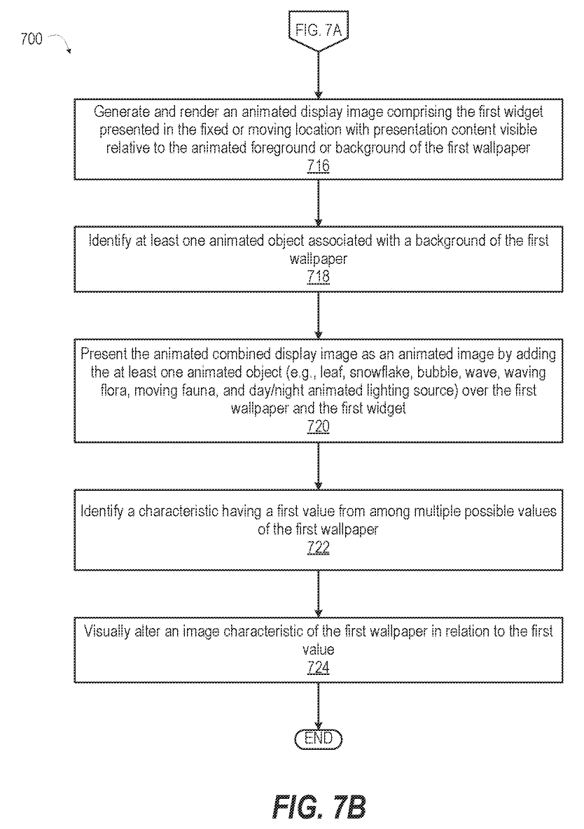

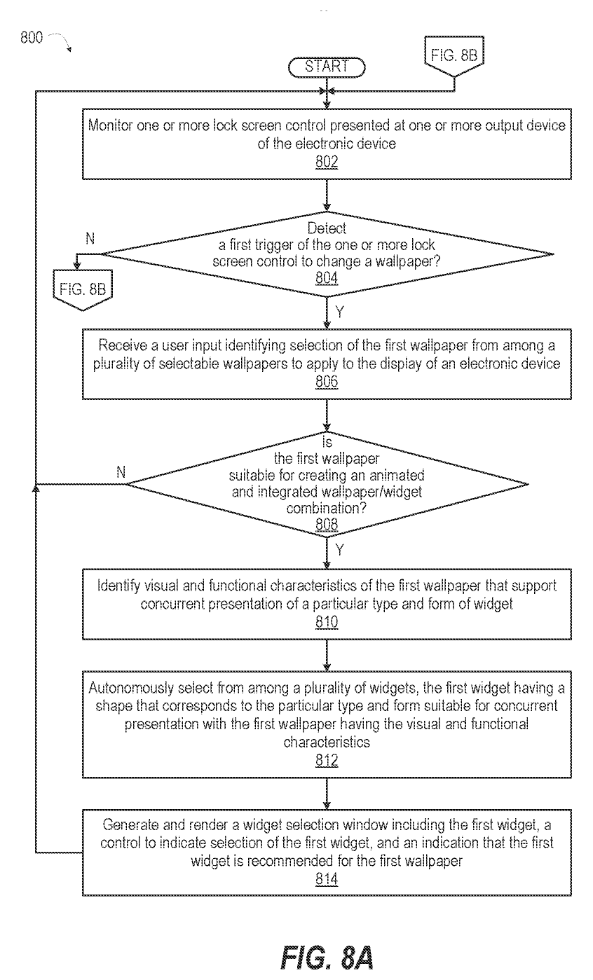

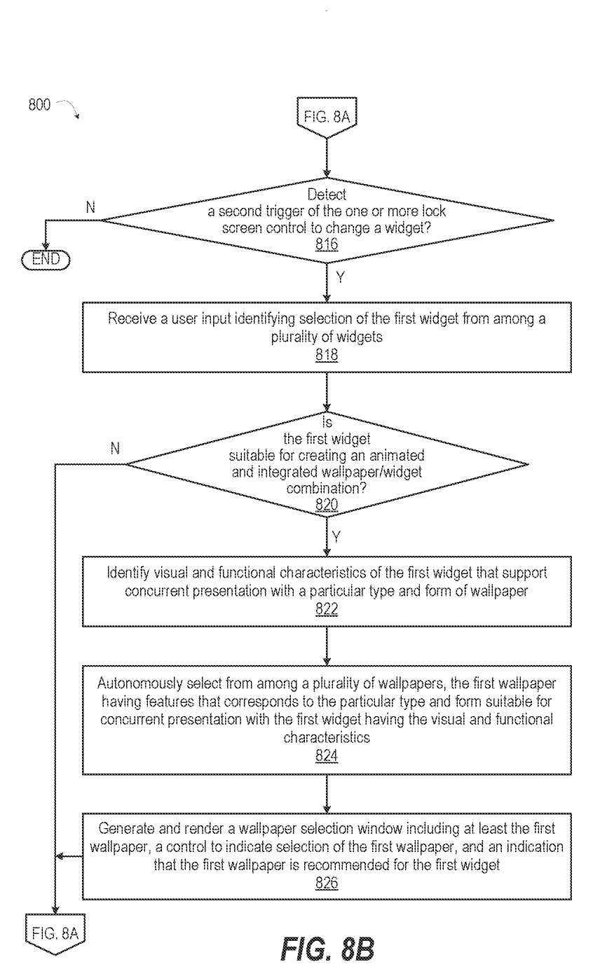

FIGS. 7A - 7B (collectively "FIG. 7") are a flow diagram presenting method 700 for creating an animated combination of wallpaper and widget for displaying by an electronic device. FIGS. 8A - 8B (collectively "FIG. 8") are a flow diagram presenting method 800 that may augment method 700 (FIG. 7) for providing wallpaper and widget selection interface window that prompts finding combination(s) suitable for animating in the combined image. The descriptions of method 700 (FIG. 7) and method 800 (FIG. 8) are provided with general reference to the specific components illustrated within the preceding FIGS. 1A - 1B, 2, 3A - 3B, 4A - 4B, 5A - 5B, and 6A - 6B. Specific components referenced in method 700 (FIG. 7) and method 800 (FIG. 8) may be identical or similar to components of the same name used in describing preceding FIGS. 1A - 1B, 2, 3A - 3B, 4A - 4B, 5A - 5B, and 6A - 6B. In one or more embodiments, controller 110 (FIG. 1A) configures electronic device 100 (FIGS. 1A - 1B) or a similar computing device to provide the described functionality of method 700 (FIG. 7) and method 800 (FIG. 8).

With reference to FIG. 7A, method 700 includes identifying a display setting of an electronic device to concurrently present a first widget of one or more widget with a first wallpaper of the one or more wallpaper (block 702). Method 700 includes analyzing the first wallpaper to identify characteristics of the first wallpaper enabling one or more portion thereof to be presented as a background or a foreground image (block 704). Method 700 includes analyzing the first widget to identify presentation content that should be visible in a foreground of the first wallpaper (block 706). Method 700 includes assigning one of a fixed and a moving location of the first widget relative to the first wallpaper presented in a background of a combined image, the location selected in part based on the identified characteristics of the first wallpaper and the presentation content (block 708). Method 700 may include determining whether the first wallpaper is an animated wallpaper (decision block 710). In response to determining that the first wallpaper is not an animated wallpaper, method 700 includes identifying one or more portions of the first wallpaper that can be presented with animated movement (block 712). In one or more embodiments, method 700 may include modifying presentation of the first wallpaper to present the one or more portions as animated portions with the animated combined display image by applying, to the animated combined display image, at least one animation effect from a group including: (i) movement of at least a portion of the first wallpaper revealing the first widget (e.g., FIGS. 4A - 4B); (ii) sliding movement of the first widget along the first wallpaper (e.g., FIGS. 3A - 3B); (iii) spinning movement of the first widget (e.g., FIGS. 5A - 5B); or (iv) aligned movement of the first widget and at least portion of the first wallpaper (e.g., FIGS. 5A - 5B) (block 714). In response to determining that the first wallpaper is an animated wallpaper in decision block 710 or after animating the object shape in block 714, method 700 proceeds to block 716 of FIG. 7B.

With reference to FIG. 7B, method 700 includes generating and rendering an animated display image comprising the first widget presented in the fixed or moving location with presentation content visible relative to the animated foreground or background of the first wallpaper (block 716). In one or more embodiments, the fixed or moving location of the first widget is selected and dynamically changeable relative to the animation of the first wallpaper. In one or more embodiments, method 700 includes identifying at least one animated obj ect associated with a background of the first wallpaper (block 718). Method 700 includes presenting the animated combined display image as an animated image by adding the at least one animated object (e.g., leaf, snowflake, bubble, wave, waving flora, moving fauna, and day/night animated lighting source) over the first wallpaper and the first widget (block 720). In one or more embodiment, the first wallpaper is otherwise not an animated wallpaper. Method 700 includes identifying a characteristic having a first value from among multiple possible values of the first wallpaper (block 722). Method 700 includes visually altering an image characteristic of the first wallpaper in relation to the first value (block 724). In an example, method 700 includes continuously and incrementally recoloring pedals and/or leaves of fresh rose 602a (FIG. 6A) as described above in relation to a device operating state (e.g., battery power level) to become partially wilted rose 602b (FIG. 6B). Then method 700 ends.

According to aspects of the present disclosure, method 700 may include identifying a display setting to concurrently present a first widget of one or more widget with a first wallpaper of the one or more wallpaper. Method 700 may include analyzing the first wallpaper to identify characteristics of the first wallpaper enabling one or more portion thereof to be presented as a background or a foreground image. Method 700 may include analyzing the first widget to identify presentation content that should be visible in a foreground of the first wallpaper. Method 700 may include assigning one of a fixed and a moving location of the first widget relative to the first wallpaper presented in a background of a combined image. The location is selected in part based on the identified characteristics of the first wallpaper and the presentation content. Method 700 may include generating and rendering an animated combined display image including the first widget presented in the assigned one of the fixed or the moving location with presentation content visible relative to the foreground or background of the first wallpaper.

With reference to FIG. 8A, method 800 includes monitoring one or more lock screen control presented at one or more output device(s) of the electronic device (block 802). Method 800 includes detecting whether a first trigger of the one or more lock screen control to change a wallpaper is detected (decision block 804). In response to determining that the first trigger to change the wallpaper is detected, method 800 includes receiving a user input identifying selection of the first wallpaper from among a plurality of selectable wallpapers to apply to the display of an electronic device (block 806). In one or more embodiments, the available wallpapers may include at least one wallpaper that lacks features for animating or guiding animation as part of animated combined display image 270 (FIG. 2). In an example, the wallpaper may be a solid color background. Method 800 may include determining whether the first wallpaper is suitable for creating an animated and integrated wallpaper/widget combination (decision block 808). In response to determining that the first wallpaper is not suitable for creating an animated and integrated wallpaper/widget combination, method 800 returns to block 802 to monitor for additional user selected changes to the wallpaper or widget. In response to determining that the first wallpaper is suitable for creating an animated and integrated wallpaper/widget combination, method 800 includes identifying visual and functional characteristics of the first wallpaper that support concurrent presentation of a particular type and form of widget (block 810). Method 800 includes autonomously selecting from among a plurality of widgets, the first widget having a shape that corresponds to the particular type and form suitable for concurrent presentation with the first wallpaper having the visual and functional characteristics (block 812). Method 800 includes generating and rendering a widget selection window including the first widget, a control to indicate selection of the first widget, and an indication that the first widget is recommended for the first wallpaper (block 814). Then method 800 returns to block 802 to monitor for additional user selected changes to the wallpaper or widget. In response to determining that the first trigger to change the wallpaper is not detected in decision block 804, then method 800 proceeds to block 816 of FIG. 8B.

With reference to FIG. 8B. method 800 includes detecting whether a second trigger of the one or more lock screen control to change a widget is detected (decision block 816). In response to determining that the second trigger to change the widget is not detected, method 800 ends. In response to determining that the second trigger to change the widget is detected, method 800 includes receiving a user input identifying selection of the first widget from among a plurality of widgets (block 818). In one or more embodiments, the available widgets may include at least one widget that lacks features for animating or guiding animation as part of animated combined display image 270 (FIG. 2). In an example, the widget may require full screen presentation, providing no option for movement across the display. Method 800 may include determining whether the first widget is suitable for creating an animated and integrated wallpaper/widget combination (decision block 820). In response to determining that the first widget is not suitable for creating an animated and integrated wallpaper/widget combination, method 800 returns to block 802 (FIG. 8A) to monitor for subsequent user selections. In response to determining that the first widget is suitable for creating an animated and integrated wallpaper/widget combination, method 800 includes identifying visual and functional characteristics of the first widget that support concurrent presentation with a particular type and form of wallpaper (block 822). Method 800 includes autonomously selecting from among a plurality of wallpapers, the first wallpaper having features that corresponds to the particular type and form suitable for concurrent presentation with the first widget having the visual and functional characteristics (block 824). Method 800 includes generating and rendering a wallpaper selection window including at least the first wallpaper, a control to indicate selection of the first wallpaper, and an indication that the first wallpaper is recommended for the first widget (block 826). To receive a new user selection, method 800 returns to block 802 (FIG. 8A). For clarity, one widget may be selected. In one or more embodiments, display size may enable more than one widget to be selected and to integrated and animated with features of the wallpaper.

According to aspects of the present disclosure, the electronic device 100 (FIG. 1A), method 700 (FIG. 7), method 800 (FIG. 8), and computer program product, such as RSD 145 (FIG. 1A), provide techniques for creating an animated combination of wallpaper and widget for displaying by an electronic device. The techniques create appealing and eye-catching home screens that combine animated and integrated wallpaper features with useful information from a widget, personalizing the electronic device and improving user experience. In one or more embodiments, the techniques include providing wallpaper and widget selection interface window. In response to a user selecting one of a widget or a wallpaper, the electronic device finds the other one of the widget and the wallpaper to find a combination suitable for animating in the combined image.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a "circuit," "module" or "system."

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms "a", "an", and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device, comprising:
a display;
a memory comprising (i) a widget and background integration (WBI) module; (ii) one or more widget; and (iii) one or more wallpaper; and
a processor communicatively coupled to the display and the memory, and which is configured to cause the electronic device to:
identify a display setting to concurrently present a first widget of the one or more widget with a first wallpaper of the one or more wallpaper;
analyze the first wallpaper to identify characteristics of the first wallpaper enabling one or more portion thereof to be presented as a background or a foreground image;
analyze the first widget to identify presentation content that should be visible in a foreground of the first wallpaper;
assign one of a fixed and a moving location of the first widget relative to the first wallpaper presented in a background of a combined image, the location selected in part based on the identified characteristics of the first wallpaper and the presentation content; and
generate and render an animated combined display image comprising the first widget presented in the assigned one of the fixed or the moving location with presentation content visible relative to the foreground or background of the first wallpaper.

2. The electronic device of claim 1, wherein the processor is configured to cause the electronic device to:
in response to receiving a user input identifying selection of the first wallpaper from among a plurality of selectable wallpapers to apply to the display of the electronic device:
identify visual and functional characteristics of the first wallpaper that support concurrent presentation of a particular type and form of widget; and
autonomously select, from among a plurality of widgets, the first widget having a shape that corresponds to the particular type and form suitable for concurrent presentation with the first wallpaper having the visual and functional characteristics.

3. The electronic device of claim 1, wherein the processor is configured to cause the electronic device to:
in response to receiving a user input identifying selection of the first widget from among a plurality of widgets:
identify visual and functional characteristics of the first widget that support concurrent presentation with a particular type and form of wallpaper; and
autonomously select from among a plurality of wallpapers, the first wallpaper having features that correspond to the particular type and form suitable for concurrent presentation with the first widget having the visual and functional characteristics.

4. The electronic device of claim 1, wherein:
the first widget presents a characteristic having a first value from among multiple possible values; and
the processor is configured to cause the electronic device to visually alter an image characteristic of the first wallpaper in relation to the first value.

5. The electronic device of claim 1, wherein the first wallpaper is animated and the fixed or moving location of the first widget is selected and dynamically changeable relative to the animation of the first wallpaper.

6. The electronic device of claim 1, wherein the processor is configured to cause the electronic device to:
in response to the first wallpaper not being an animated wallpaper:
identify one or more portions of the first wallpaper that can be presented with animated movement; and
modify a presentation of the first wallpaper to present the one or more portions as animated portions within the animated combined display image.

7. The electronic device of claim 1, wherein the processor is configured to cause the electronic device to apply, to the animated combined display image, at least one animation effect from a group comprising: (i) movement of at least a portion of the first wallpaper revealing the first widget; (ii) sliding movement of the first widget along the first wallpaper; (iii) spinning movement of the first widget; or (iv) aligned movement of the first widget and at least a portion of the first wallpaper.

8. The electronic device of claim 1, wherein in response to the first wallpaper not being an animated wallpaper, the processor is configured to cause the electronic device to present the animated combined display image as an animated image by adding at least one animated object over the first wallpaper and the first widget.

9. The electronic device of claim 8, wherein the at least one animated object comprises one or more of: (i) leaf; (ii) snowflake; (iii) bubble; (iv) wave; (v) waving flora; (vi) moving fauna; and (vii) day/night animated lighting source.

10. A method, comprising:
identifying a display setting to concurrently present a first widget of one or more widget with a first wallpaper of the one or more wallpaper;
analyzing the first wallpaper to identify characteristics of the first wallpaper enabling one or more portion thereof to be presented as a background or a foreground image;
analyzing the first widget to identify presentation content that should be visible in a foreground of the first wallpaper;
assigning one of a fixed and a moving location of the first widget relative to the first wallpaper presented in a background of a combined image, the location selected in part based on the identified characteristics of the first wallpaper and the presentation content; and
generating and rendering an animated combined display image comprising the first widget presented in the assigned one of the fixed or the moving location with presentation content visible relative to the foreground or background of the first wallpaper.

11. The method of claim 10, further comprising:
in response to receiving a user input identifying selection of the first wallpaper from among a plurality of selectable wallpapers to apply to the display of an electronic device:
identifying visual and functional characteristics of the first wallpaper that support concurrent presentation of a particular type and form of widget; and
autonomously selecting from among a plurality of widgets, the first widget having a shape that corresponds to the particular type and form suitable for concurrent presentation with the first wallpaper having the visual and functional characteristics.

12. The method of claim 10, further comprising:
in response to receiving a user input identifying selection of the first widget from among a plurality of widgets:
identifying visual and functional characteristics of the first widget that support concurrent presentation with a particular type and form of wallpaper; and
autonomously selecting from among a plurality of wallpapers, the first wallpaper having features that corresponds to the particular type and form suitable for concurrent presentation with the first widget having the visual and functional characteristics.

13. The method of claim 10, wherein the first wallpaper presents a characteristic having a first value from among multiple possible values, and the method further comprises visually altering an image characteristic of the first wallpaper in relation to the first value.

14. The method of claim 10, wherein the first wallpaper is animated and the fixed or moving location of the first widget is selected and dynamically changeable relative to the animation of the first wallpaper.

15. The method of claim 10, further comprising:
in response to the first wallpaper not being an animated wallpaper:
identifying one or more portions of the first wallpaper that can be presented with animated movement; and
modifying a presentation of the first wallpaper to present the one or more portions as animated portions within the animated combined display image.

16. The method of claim 10, further comprising:
applying, to the animated combined display image, at least one animation effect from a group comprising: (i) movement of at least a portion of the first wallpaper revealing the first widget; (ii) sliding movement of the first widget along the first wallpaper; (iii) spinning movement of the first widget; or (iv) aligned movement of the first widget and at least portion of the first wallpaper.

17. The method of claim 10, further comprising:
in response to the first wallpaper not being an animated wallpaper:
presenting the animated combined display image as an animated image by adding at least one animated object over the first wallpaper and the first widget.

18. The method of claim 17, further comprising adding the at least one animated object comprising one or more of: (i) leaf; (ii) snowflake; (iii) bubble; (iv) wave; (v) waving flora; (vi) moving fauna; and (vii) day/night animated lighting source.

19. A computer program product comprising:
a computer readable storage device; and
program code on the computer readable storage device that when executed by a processor associated with an electronic device, the program code is configured to cause the electronic device to provide functionality of:
identifying a display setting to concurrently present a first widget of one or more widget with a first wallpaper of the one or more wallpaper;
analyzing the first wallpaper to identify characteristics of the first wallpaper enabling one or more portion thereof to be presented as a background or a foreground image;
analyzing the first widget to identify presentation content that should be visible in a foreground of the first wallpaper;
assigning one of a fixed and a moving location of the first widget relative to the first wallpaper presented in a background of a combined image, the location selected in part based on the identified characteristics of the first wallpaper and the presentation content; and
generating and rendering an animated combined display image comprising the first widget presented in the assigned one of the fixed or the moving location with presentation content visible relative to the foreground or background of the first wallpaper.

20. The computer program product of claim 19, wherein the program code is further configured to cause the electronic device to provide functionality of:
applying, to the animated combined display image, at least one animation effect from a group comprising: (i) movement of at least a portion of the first wallpaper revealing the first widget; (ii) sliding movement of the first widget along the first wallpaper; (iii) spinning movement of the first widget; or (iv) aligned movement of the first widget and at least portion of the first wallpaper.
